(19) United States
(12) Patent Application Publication
(10) Pub. No.: US 2015/0166067 A1
(43) Pub. Date: Jun. 18, 2015

(54) SYSTEM AND METHOD FOR CONTROLLING THE SPEED OF AN ENGINE

(71) Applicant: Scania CV AB, Södertälje (SE)

(72) Inventors: Karl Rredbrandt, Solna (SE); Andreas Laghamn, Sodertalje (SE); Fredrik Sundén, Hagersten (SE); Mikael Wågberg, Enhorna (SE)

(21) Appl. No.: 14/388,873

(22) PCT Filed: Feb. 26, 2013
(86) PCT No.: PCT/SE2013/050172

§ 371 Date: Sep. 29, 2014

(30) Foreign Application Priority Data
Mar. 30, 2012 (SE) 1250320-7

(51) Int. Cl. B60W 30/188; B60W 10/06; B60W 10/02

(52) U.S. Cl. CPC B60W 30/1884; B60W 10/02; B60W 10/06

(57) ABSTRACT

A method for regulating the speed of an engine of a vehicle, the vehicle being provided with a clutch which is operated by a vehicle control system for selectively connecting the engine to a gearbox for transmission of torque. When the speed of the engine is to be guided towards a set-point value, the speed of the engine is regulated by using the control system to regulate the torque transmitted by the clutch. Also a system performing the method and a vehicle comprising the system.

### FIELD OF THE INVENTION

The present invention relates to a method for use in regulating the speed of an engine in a vehicle. The invention relates in particular to a method for regulating the speed of an engine of a vehicle according to the preamble of claim 1. It relates also to a system and a vehicle and to a computer programme and a computer programme product which implement the method according to the invention.

### BACKGROUND TO THE INVENTION

In vehicles in general there are many different power train configurations, e.g. the gearbox may be manually operated or automatic. It is often desirable that it be possible for heavy vehicles to run in as comfortable a way for the driver as possible, which usually entails the gear changes in the gearbox being effected automatically by means of the vehicle's control system. Automatically operated gearboxes have therefore also become increasingly usual in heavy vehicles.

The efficiency of automatic gearboxes of the kind often used in cars is in many cases too low for their use to be justified other than in, for example, urban buses and distribution vehicles in towns which usually have frequently to come to a halt and then move off again. It is however becoming increasingly common for these kinds of vehicles also to be provided with power trains of the type described below.

Automatic gear changing in heavy vehicles is often effected by using control systems to effect gear changes in “manual” gearboxes, i.e. gearboxes comprising one pair of gearwheels per gear, with the gear ratios spread at suitable intervals, e.g. because these gearboxes are substantially less expensive to make but also because of their greater efficiency compared with conventional automatic gearboxes. Such gearboxes are connected to the vehicle's engine by a clutch which may be automatically operated by one of the vehicle's control systems.

In principle, the clutch in such vehicles need only be used when setting them in motion from stationary, as other gear changes may be effected by the vehicle's control system without the clutch being opened. In cases where the clutch is operated automatically by one of the vehicle's control systems, the clutch is nevertheless often used to open/close the power train even during gear changes. The automatically operated clutch may for example be operated by using the vehicle's control system to operate a clutch actuator.

### SUMMARY OF THE INVENTION

An object of the present invention is to propose a method for regulating the speed of an engine of a vehicle. This object is achieved with a method according to claim 1.

The present invention relates to a method for regulating the speed of an engine of a vehicle, where said vehicle comprises a clutch operated by a vehicle control system and said clutch is arranged to selectively connect said engine to a gearbox for transmission of torque. When the speed of said engine is to be guided towards a set-point value, it is regulated by using said control system to regulate the torque transmitted by said clutch.

The present invention thus relates to vehicles where a clutch is provided to selectively connect an engine, e.g. a combustion engine, to a gearbox, e.g. a gearbox with a plurality of gear ratios, such as a “manual” gearbox which has fixed gear ratios and is operated by a control system.

When setting a vehicle of this kind in motion, e.g. from stationary, a force, e.g. that represented by a torque delivered by the engine or a desired propulsive force on the vehicle's tractive wheels, is normally demanded, e.g. by a driver via an acceleration means such as an accelerator pedal. In response to such demand the vehicle's control system will endeavour to direct desired force to the vehicle's tractive wheels via said clutch and gearbox. Propulsive force on the vehicle's tractive wheels means the resulting force applied to them when the torque delivered by the engine has been converted to said force, as is familiar to one skilled in the art, on the basis of gear ratio, wheel radius and the efficiency of the power train components.

This is usually achieved by suitable parts of the vehicle's control system demanding speed control of the combustion engine while at the same time the clutch is operated in such a way that a desired amount of torque is delivered by the engine. This type of control involves sliding of the clutch, and to make it possible for the engine to be controlled in a desired way the clutch must not transmit more torque than the engine can momentarily deliver, since this would result in the engine being braked by the rest of the power train with a greater braking force (i.e. counterforce) which would quickly lower the engine's speed, leading in the worst case to the engine stalling if the clutch does not quickly reopen to reduce the load upon the engine and thereby make it possible for its speed to be raised.

Such situations are undesirable in that speed variations of this kind typically result in poor driving sensation and impaired comfort. Avoiding such situations usually involves applying a safety margin whereby the clutch is operated in such a way that it will never transmit a greater force than a certain proportion of the engine's momentary maximum torque, i.e. a safety margin with respect to the engine's momentary maximum torque.

This does however mean that it will not be possible to take out the engine's maximum torque, with the result that setting the vehicle in motion, particularly in arduous situations, as in the case of a heavily laden vehicle moving off uphill, may in the worst case be impossible because the safety margin prevents full utilisation of the engine's torque despite its being available in “hardware” terms.

The present invention employs a different type of control whereby such margins can be avoided and a larger amount of torque can for example be made available when setting the vehicle is motion.

According to the invention, the speed of the engine is regulated by using the vehicle's control system to regulate the torque transmitted by said clutch. Using the clutch to control the engine's speed may provide constant assurance that it will not drop to an undesirably low level. The torque transmissible (transmitted) by the clutch may for example be reduced when the engine's speed is to be raised, and may conversely be raised if the speed is to be lowered. The speed regulation may be conducted on the basis of control signals containing a desired set-point value for the engine's speed, which may then be regulated towards this set-point value by means of the clutch. This also means that the function which regulates the clutch needs no access to information other than the set-point value for the engine's speed, and said speed, which may then be regulated towards this set-point value by means of the clutch. Control of the torque delivered by the engine is not in itself subject matter of the present invention, as it may controlled in any suitable way. For example, a demand for torque from the engine may be arranged to ensure that sufficient torque is constantly demanded so that desired increases in the torque in the power train can also be accommodated, e.g. when moving off. Since speed control of the engine is regulated by regulating the torque transmitted by the clutch, the torque demanded by the engine may also be arranged to depend on a desired engine speed derivative (acceleration/braking) during the regulation of the engine's speed.

The regulating function for the engine speed may be conducted by means of a characteristic for the torque transmissible by the clutch relative to the regulating position of, for example, a clutch actuator, in which case the torque transmissible by the clutch may be accurately controlled in such a way that the engine speed is guided towards desired speed.

The torque transmissible by the clutch may for example be reduced by moving the clutch from closed position towards open position, in which case the torque transmissible by it decreases progressively as it moves towards open position, and the torque transmissible by the clutch may conversely be increased by moving it towards closed position, whereby the torque transmissible by the clutch will increase progressively as it moves towards closed position. A clutch characteristic as above is preferably employed in this regulation.

So long as said clutch is sliding, the torque transmissible by it, and hence the engine speed, may be regulated entirely by means of the clutch. However, the characteristic of the clutch is such that a sliding clutch can only transmit a torque with the same arithmetical sign as the difference in rotation speed. In other words, a positive (i.e. propulsive) torque can only be transmitted from the side of the clutch which has the higher rotation speed. This means that a sliding clutch only allows positive torque to be transmitted from the engine (the engine side of the clutch) so long as the speed of the engine output shaft is greater than that of the opposite side of the clutch (the gearbox side), which is usually rotationally locked to the gearbox input shaft. In other words, it is not possible to accommodate negative (i.e. braking) torque in this situation. At times when the speed of the gearbox input shaft is greater than the engine's idling speed, the opposite is the case, i.e. it is possible for negative (braking) torque to be transmitted from the engine. The present invention is applicable irrespective of whether propulsive or braking torque is transmitted via the clutch, so long as the speed criterion as above is fulfilled.

Further characteristics of the present invention and advantages thereof are indicated by the detailed description of embodiment examples set out below and the attached drawings.

### BRIEF DESCRIPTION OF THE DRAWINGS

FIG. 1A depicts a power train of a vehicle on which the present invention may with advantage be employed.

FIG. 1B depicts a control unit in a vehicle control system.

FIG. 2 depicts schematically the torque deliverable by a vehicle engine as a function of engine speed.

FIG. 3 depicts schematically a method according to an embodiment example of the present invention.

FIG. 4 illustrates an example of a function division according to the present invention.

### DETAILED DESCRIPTION OF PREFERRED EMBODIMENTS

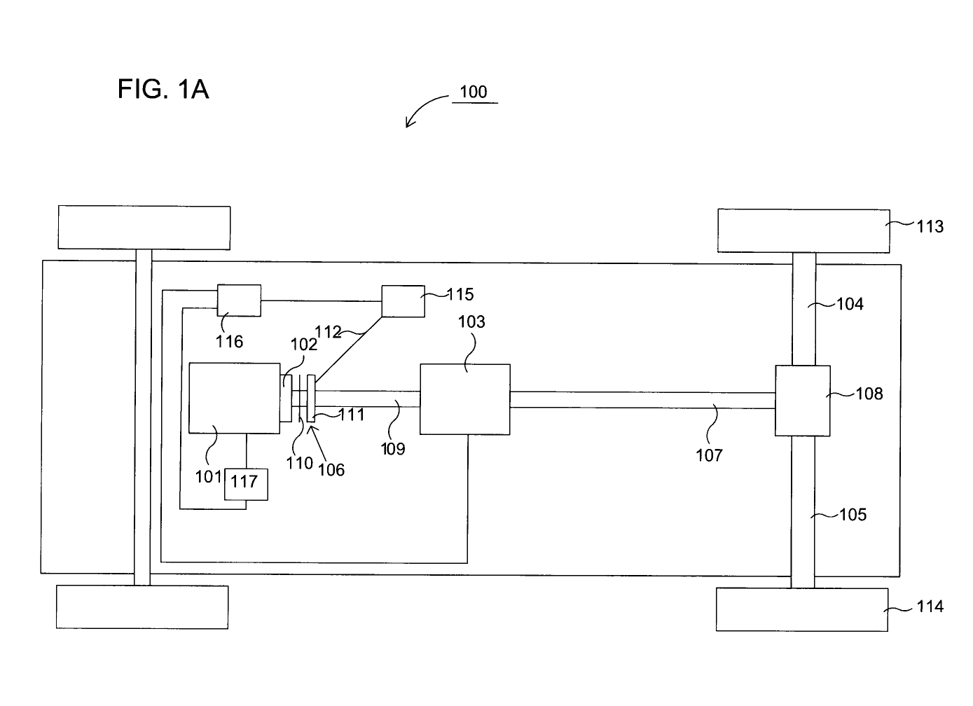

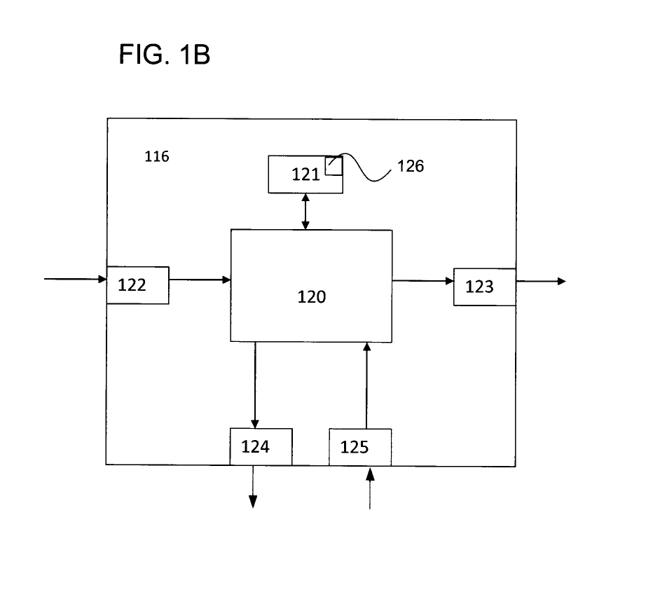

FIG. 1A depicts schematically a power train of a vehicle 100 according to an embodiment of the present invention. The vehicle depicted has only one axle 104, 105 with tractive wheels 113, 114 but the invention is also applicable on vehicles in which more than one axle is provided with tractive wheels, and on vehicles with one or more further axles, e.g. one or more tag axles. The power train comprises an engine, in this example a combustion engine 101, which in a conventional way, via an output shaft of the engine, usually via a flywheel 102, is connected to a gearbox 103 via a clutch 106.

The clutch 106 takes the form of an automatically operated clutch and in this embodiment is of a type in which a friction element (e.g. a disc) 110 connected to a first gearbox element, e.g. the gearbox input shaft 109, engages selectively with the engine's flywheel 102 to transmit torque from the engine to the tractive wheels 113, 114 via the gearbox. Alternatively, instead of engaging with the flywheel 102, the friction element 110 may engage with another friction element firmly connected to, for joint rotation with, the engine. The clutch may for example be of a dry or wet plate type or some other suitable type, e.g. a double clutch box with wet or dry clutches. In the present example the engagement of the friction element 110 with the engine output shaft/the flywheel 102 is controlled by means of a pressure plate 111 which is movable in axial directions, e.g. by means of a lever arm 112, and whose function/movement is controlled by a clutch actuator 115. The action of the clutch actuator upon the lever arm 112 is controlled by the vehicle's control system via a control unit 116. The clutch actuator may for example comprise one or more pneumatically operated pistons which act upon the lever arm, the clutch thus being opened/closed by said pistons effecting a lever arm movement. The clutch actuator may also be of an electric or other suitable type.

An output shaft 107 of the gearbox 103 then drives the tractive wheels 113, 114 via a final gear 108, e.g. a conventional differential, and driveshafts 104, 105 which are connected to said final gear.

When a vehicle 100 with an automatically operated clutch of the type here concerned has for example to be set in motion from stationary, this is normally achieved by the vehicle's driver demanding work, which may be represented by a torque delivered by the engine, e.g. by using an accelerator pedal. When this torque is demanded, the vehicle's control system will try to direct it to the vehicle's tractive wheels 113, 114 via the clutch 106 and the gearbox 103, resulting in a desired propulsive force acting upon said tractive wheels. This is achieved by a speed control of the engine being demanded, e.g. by a comprehensive function which takes care of the vehicle being set in motion in a desired way, which speed regulation is then conducted by the control unit 117 which controls the engine. At the same time, the clutch 106 is operated in such a way that a desired torque is transmitted to the gearbox/the remainder of the power train, and the increase in the torque transmitted by the clutch when the vehicle is moving off may for example be arranged to follow any suitable curve/function, e.g. a curve/function whereby the torque increase per unit time takes place in a desired way. This increase may for example proceed until the torque transmitted by the clutch causes a prevailing running resistance to be overcome and the vehicle therefore to begin to move in the appropriate direction.

This control may be conducted while the clutch is sliding, since only then is the power train torque controlled by the clutch actuator. When the clutch has slid together, the torque transmitted by it is controlled instead by the engine's torque so long as the clutch can cope with transmitting it. When the engine's torque is greater than the maximum torque transmissible in the prevailing position of the clutch, the clutch will again begin to slide.

In addition, to enable the engine to be speed-controlled, the clutch is not allowed to transmit more torque than the engine can momentarily deliver, since this would result in a braking force from the more slowly rotating power train downstream of the clutch, causing the engine's speed to drop quickly. This would mean the clutch having to reopen quickly to reduce the load upon the engine and thereby make it possible to return to desired engine speed. Such situations, particularly if they recur, are undesirable in that the speed variations result in poor driving sensation and impaired comfort for the vehicle's driver.

With a view to avoiding such situations, a safety margin is therefore usually applied so that the clutch is operated in such a way that when for example the vehicle is being set in motion the clutch does not transmit more than a certain proportion of the engine's momentary maximum torque, i.e. a safety margin with respect to the engine's momentary maximum torque is applied.

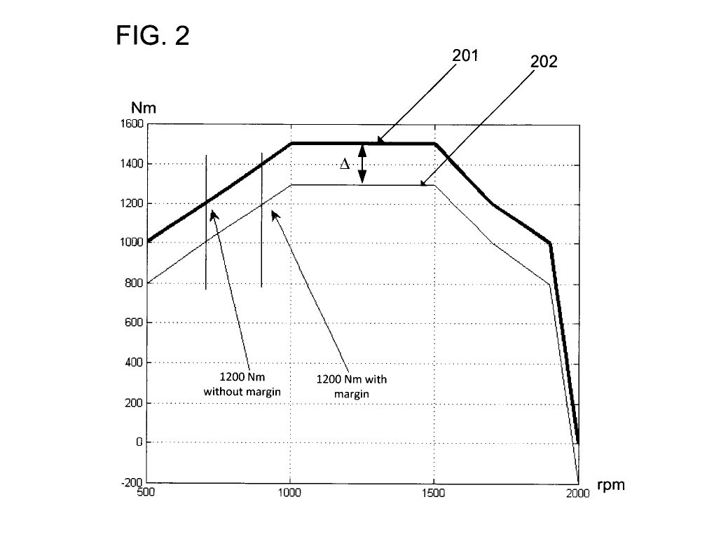

This is illustrated in FIG. 2, in which curve 201 represents the maximum torque which the engine can actually deliver, as a function of engine speed. Curve 202 is a corresponding torque curve but with a safety margin Δ applied. In for example a situation where the vehicle's running resistance is such that at least for example 1200 Nm in the respective gear is required to set the vehicle in motion, as when moving off uphill heavily laden, the safety margin applied in FIG. 2 means that the engine's speed has to be raised to about 900 rpm for the control system to allow the clutch to transmit 1200 Nm and thereby achieve a corresponding force on the vehicle's tractive wheels 113, 114. Had there been no need to apply this safety margin, the vehicle might instead have been set in motion from stationary at an engine speed of 700 rpm, resulting for example in substantially less clutch wear since in this situation the clutch might slide with a smaller speed difference and also for a shorter time.

Applying the safety margin Δ illustrated also entails the disadvantage that the higher speed at which the engine consequently runs will cause it to deliver a higher power output which will merely be converted immediately to friction heat when the clutch slides, leading to further disadvantages such as undesirable temperature rise.

As may be seen in FIG. 2, operating with application of safety margin also means that it will never be possible to take out maximum torque from the engine when the vehicle is being set in motion. If the torque requirement at the time for the vehicle in the example illustrated was instead 1400 Nm, the safety margin applied would make it impossible for the vehicle to move off at all, despite the fact that its actual performance makes it possible to do so on as little as 900 rpm. A move-off procedure with safety margin applied does for example mean that vehicles/vehicle types carrying heavy loads in situations where moving off is difficult may well remain stationary despite the torque deliverable by the engine actually being perfectly sufficient to enable the vehicle to move off.

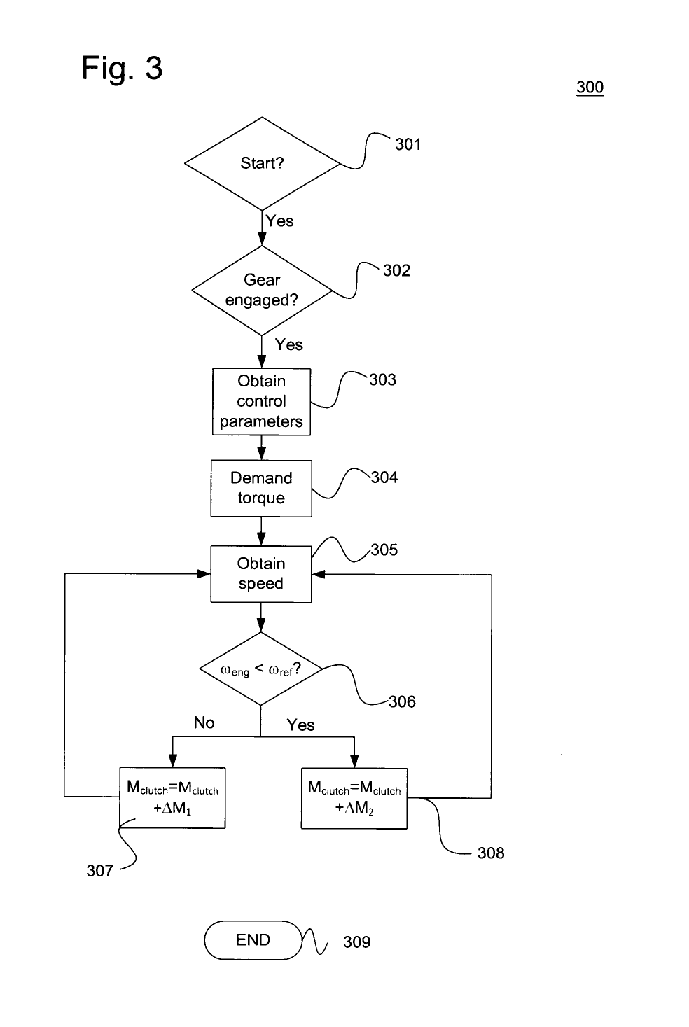

The present invention proposes an alternative method for setting a vehicle in motion which makes it possible to utilise substantially more or even the whole of the maximum torque deliverable by the engine. A method example 300 according to the present invention is illustrated in FIG. 3 and further explained below.

The invention may be implemented in any suitable control unit, but in the present example it is implemented in the control unit 116 depicted in FIG. 1A which controls the clutch.

Control systems in modern vehicles usually comprise a communication bus system consisting of one or more communication buses to connect a number of electronic control units (ECUs), or controllers, to various components on board the vehicle. Such a control system may comprise a large number of control units, and taking care of a specific function may be shared between two or more of them.

For the sake of simplicity, FIG. 1A shows only control units 116, 117, but one skilled in the art will appreciate that vehicles of the type here concerned often have significantly more control units.

The control unit 116 in which the present invention in the embodiment depicted is therefore implemented operates the clutch 106 (the clutch actuator 115) and also the gearbox 103. The invention may alternatively be implemented in a control unit dedicated for the present invention, or wholly or partly in one or more other control units with which the vehicle is already provided, e.g. the control unit 117 which in the present example controls the vehicle's engine.

The control exercised by control unit 116 (or the control unit or units in which the present invention is implemented) will according to the present invention probably depend on signals received from the control unit or units which control engine functions, i.e. in the present case control unit 117. Control unit 116 will probably also receive signals from undepicted other control units with which the vehicle is provided, and/or information from, for example, various sensors and the like with which the vehicle is provided. Control unit 116 may for example be arranged to receive signals which represent respective rotation speeds of the engine output shaft and the gearbox input shaft, making it possible to determine a speed difference across the clutch, i.e. clutch slip. Control unit 116 may also be arranged to receive signals concerning the position of the friction element and/or the lever arm. Control units of the type here concerned are usually arranged to receive sensor signals from different parts of the vehicle.

Control units of the type here concerned are also usually arranged to deliver control signals to various parts and components of the vehicle. Control unit 116 may for example demand/order operation of the clutch actuator in desired ways and may also, in one embodiment of the present invention, demand a torque delivered from said engine, e.g. via control unit 117.

Control is often governed by programmed instructions, typically in the form of a computer programme which, when executed in a computer or control unit, causes the computer/control unit to effect desired forms of control action, e.g. method steps according to the present invention.

The computer programme is usually part of a computer programme product which comprises a suitable storage medium 121 (see FIG. 1B), which has stored on it the computer programme 126. Said digital storage medium 121 may for example take the form of any from among ROM (read-only memory), PROM (programmable read-only memory), EPROM (erasable PROM), flash memory, EEPROM (electrically erasable PROM), a hard disc unit etc., and be situated in or in communication with the control unit, in which case the computer programme will be executed by the control unit. The vehicle's behaviour in a specific situation is therefore modifiable by altering the computer programme's instructions.

A control unit example (control unit 116) depicted schematically in FIG. 1B may comprise a calculation unit 120 which may for example take the form of any suitable kind of processor or microcomputer, e.g. a circuit for digital signal processing (Digital Signal Processor, DSP), or a circuit with a predetermined specific function (Application Specific Integrated Circuit, ASIC). The calculation unit is connected to a memory unit 121 which provides it with, for example, the stored programme code 126 and/or the stored data which the calculation unit needs to enable it to perform calculations. The calculation unit is also arranged to store partial or final results of calculations in the memory unit 121.

Control unit 116 is further provided with respective devices 122, 123, 124, 125 for receiving and sending input and output signals. Said signals may comprise waveforms, pulses or other attributes which the input signal receiving devices 122, 125 can detect as information for processing by the calculation unit 120. The output signal sending devices 123, 124 are arranged to convert calculation results from the calculation unit to output signals for conveying to other parts of the vehicle's control system and/or the component or components for which they are intended. Each of the connections to the respective devices for receiving and sending input and output signals may take the form of one or more from among a cable, a data bus, e.g. a CAN (Controller Area Network) bus, a MOST (Media Oriented Systems Transport) bus or some other bus configuration, or a wireless connection.

Reverting to the method illustrated in FIG. 3, step 301 determines whether the vehicle is to be set in motion. This may for example be based on determining whether the vehicle's driver indicates such a demand, e.g. by using an accelerator pedal as above. It should be noted that although the present example is concerned with a vehicle moving off, there may also be other situations in which the present invention is applicable, such as when changing gear or other situations in which using the clutch to control the speed of the engine may be applicable. The invention thus relates to control of the engine's speed by means of the clutch in such situations.

The relationship between accelerator pedal position and corresponding operation of the vehicle's engine may present differently, and many cases involve the use of charting between accelerator pedal and engine control whereby the driver uses the accelerator pedal to demand a given torque, and the pedal's movement region may for example represent 0-1000 of the maximum torque which the engine can deliver, or 0-1000 of the torque required to enable the vehicle (in the respective gear) to overcome prevailing running resistance and begin to move. The charting may also be arranged to vary depending on the prevailing type of driving situation and may for example be of one kind when the vehicle is being set in motion from stationary, and another kind during subsequent movement. Such charting is however, not subject matter of the present invention.

If the vehicle's driver thus delivers in a suitable way an indication that the vehicle is to be set in motion, e.g. by appropriate operation of an accelerator pedal, the method moves on to step 302 to decide whether a desired gear is engaged in the vehicle's gearbox 103. This gear may for example be chosen entirely by the vehicle's control system or by the driver, or alternatively by the control system on the basis of an indication from the driver. When step 302 has determined that a gear is engaged in the gearbox, the method moves on to step 303 to determine control parameters as below. In the present example, a control function TRAM (transmission manager) 410 in control unit 116 also determines as below a demand for a torque to be taken out from the vehicle's engine 101 and/or a desire for a certain propulsive force on the vehicle's tractive wheels 113, 114, e.g. to overcome a prevailing running resistance. The magnitude of this demand may be determined in any suitable way and may for example be controlled by the control function TRAM 410 or some other comprehensive function which takes care of the way in which the vehicle is to be set in motion. This control function or other suitable control means may also determine for example how quickly the propulsive force directed to the vehicle's tractive wheels is to be increased. This control may be conducted in a many different ways and is not in itself subject matter of the present invention. The present invention relates only to a specific way of regulating the engine's speed by means of the vehicle's clutch.

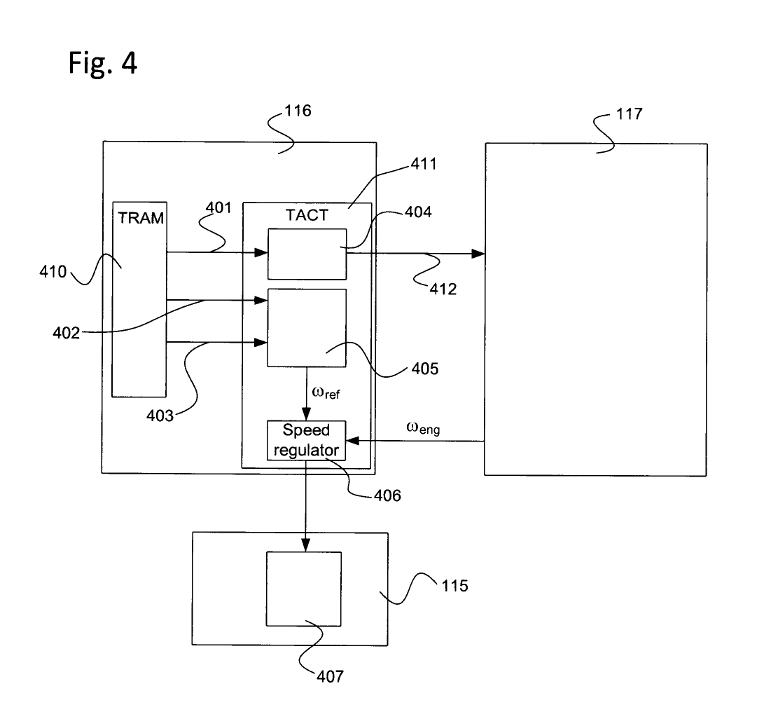

As above, the present invention in one embodiment is implemented in the control unit 116 which controls the clutch 106 and the gearbox 103. FIG. 4 illustrates an example of how a control function division may be organised according to the present invention. It depicts schematically the control unit 116 and an example of a set of functions which may take place therein according to an embodiment of the present invention. It also depicts the control unit 117 and the clutch actuator 115. The embodiment depicted illustrates an example of division of control functions, two or more of which may, as one skilled in the art will appreciate, be integrated in a single control function.

As depicted in FIG. 4, control unit 116 may comprise a plurality of function elements, the control function TRAM 410 in the present example comprises the comprehensive function for setting the vehicle in motion, determines said control parameters for the purpose and provides them at step 303. In addition to a desired propulsive force which is then converted to a corresponding torque from the vehicle's engine, or is instead immediately indicated as a desired torque 401 delivered by the engine and may for example represent the torque towards which the engine has to be guided when the vehicle is being set in motion, e.g. 1200 Nm or 1400 Nm in the example depicted in FIG. 3, the control function TRAM 410 may further deliver a speed range within which the engine is expected to stay during the vehicle's move-off and which may for example be indicated as respective minimum speed 402 and maximum speed 403 for the move-off process.

These parameters are for example delivered to a control function TACT 411 which in the present example takes care of the actual conducting of the vehicle's move-off on the basis of indicated parameters. In one embodiment, said parameters 401-403 are only delivered at the beginning of a move-off, whereas in another embodiment changed parameter values are continuously sent from TRAM 410 to TACT 411, in which case the whole move-off process is controlled continuously by the control function TRAM 410, which continuously conveys a demand as above.

TACT 411 then sees to it that the move-off is actually conducted on the basis of indicated parameters, and does itself comprise subfunctions 404, 405 and a speed regulator function 406, subfunction 405 having the task of ensuring maintenance of desired engine speed. This is achieved by means of the speed regulator 406 as below.

The demand 401 conveyed by TRAM 410 serves as a basis for subfunction 404 to determine a torque demand in the form of a control signal 412 which is sent to control unit 117 at step 304 for delivery of torque from the vehicle's engine. The torque demand received from control unit 116 then serves as a basis for control unit 117 to guide the engine towards delivering said torque. Subfunction 404 may be arranged to substantially continuously convey the control signal 412 to control unit 117, in which case the latter will thus continually guide the torque delivered by the engine towards that indicated by the control signal 412. The specific way in which torque delivered by the engine is to be controlled is not subject matter of the present invention, as it may be conducted in any suitable way. Subfunction 404 may for example convey control signals to control unit 117 to cause the engine to deliver sufficient torque to enable desired torque also to cross the clutch, which desired torque may for example be controlled on the basis of the speed to which the engine is to be regulated.

Instead of control unit 117 also taking care in a conventional way of controlling the speed of the engine, it thus only ensures, according to the present invention, that a demanded torque is also delivered, irrespective of the engine's prevailing speed.

According to the present invention, the engine's speed regulation is therefore decoupled from the control of torque delivered, and in the example depicted subfunction 405 sees to it that the engine speed is kept within a desired range, e.g. between the aforesaid maximum and minimum speeds, or at a desired speed. This is achieved by means of the speed regulator 406, which is in principle the function which controls the engine's speed according to the present invention. Control unit 117 delivers prevailing engine speed ω_{eng} which is conveyed to the speed regulator at step 305, which is where the speed regulator also receives from subfunction 405 a set-point value ω_{ref} which represents a desired engine speed. The speed regulator then uses these data as a basis for conducting control of the engine 101 according to the present invention by suitable operation of the clutch 106.

The characteristic of the clutch, i.e. how much power/torque M_{clutch} can be transmitted across it as a function of its degree of opening, expressed for example by its prevailing state relative to fully open position or closed position, i.e. in the present example the position of the friction element and/or the lever arm relative to open/closed position, is usually determined with quite good accuracy and available to the vehicle's control system, e.g. in the form of a chart.

This characteristic may also be arranged to be estimated by the vehicle's control system in suitable situations when the vehicle is in motion, e.g. on the basis of changes in the temperature or wear of the clutch over time. Such determination is not described in more detail here but is well described in prior art.

Thus the speed regulator 106 may use the characteristic of the clutch to demand a certain position for the friction element, i.e. a certain lever arm position, whereupon a desired torque M_{clutch} will be transmitted by the clutch.

The speed ω_{ref} towards which the engine is to be guided may therefore as above be regulated by a comprehensive function, e.g. TRAM 410, in which case the speed regulator 406 may continuously receive from function 405 control signals concerning desired engine speed ω_{ref}. The clutch works as above in such a way that a given clutch position will make it possible for a given torque to be transmitted via the clutch. This applies irrespective of the actual speed difference prevailing across the clutch, i.e. irrespective of the magnitude of the actual difference between the respective speeds of the engine output shaft/flywheel and the gearbox input shaft, so that at a given degree of opening, i.e. in a certain state of the clutch, the same torque will be transmitted irrespective of the difference in rotation speed across it.

As indicated above, however, it should be noted that a greater speed difference across the clutch when a given torque is being transmitted means that more power will be converted to friction heat across the clutch, so it is desirable for there to be as small a speed difference as possible.

The reason for it being possible to use the clutch to regulate the engine's speed according to the present invention is explained by equation 1

$$\dot{ω} = \frac{{M}_{eng} - {M}_{clutch}}{J} \qquad ( eq . 1 )$$

in which J represents essential inertia in the system, e.g. the moments of inertia of the engine and the clutch. As equation 1 indicates, the engine's acceleration/deceleration is directly proportional to the difference between the torque M_{eng} delivered by the engine and the torque M_{clutch} transmitted by the clutch. If M_{eng} is greater than M_{clutch}, the engine will accelerate, i.e. the speed will rise, whereas conversely its speed will be decelerated and will therefore decrease if M_{clutch} is greater than M_{eng}, in which case the clutch will apply a braking torque to the engine output shaft. As mentioned above, M_{clutch} may be determined with relatively good accuracy by means of the clutch characteristic described above, and M_{eng} may be charted for different control parameters, e.g. amounts of fuel injected, air supplied etc. at different engine speeds, or be for example calculated directly from amounts of air/fuel supplied. One embodiment requires no knowledge of the specific torque delivered by the engine, but allows the engine's speed to be regulated by relative change in the torque transmitted by the clutch on the basis of prevailing speed and desired speed. This is further described below.

The speed regulator 406 receives a representation of prevailing engine speed ω_{eng} from control unit 117, and the speed set-point value ω_{ref} from function 405. These are compared at step 306, and if ω_{eng} is greater than ω_{f} and therefore needs lowering, the method moves on to step 307.

Knowing the torque delivered by the engine enables the speed regulator at step 307 to use equation 1 to determine suitable clutch operation for using an increase in the torque transmitted M_{clutch} by the clutch to brake the engine and thereby reduce the speed ω_{eng}. Equation 1 may be used to determine a suitable increase ΔM₁ in M_{clutch}, making it possible for the engine speed decrease to be conducted at a desired rate per unit time.

The greater the increase ΔM₁ in the torque M_{clutch} transmitted by the clutch, the more quickly will the engine speed ω_{eng} decrease. Determining a desired torque transmitted by the clutch, i.e. M_{clutch}+ΔM₁, and then using suitable control of the position of the clutch actuator 115, which in the embodiment depicted is by means of a regulator 407 situated in the clutch actuator, whereby the position is determined by means of the clutch characteristic as above, thus makes it possible for M_{clutch}, and hence the engine speed change \dot{w}, to be provided with good accuracy. Providing an increased torque over a certain time thus makes it possible for the engine's rotation speed ω_{eng} to be guided towards the desired ω_{ref}.

In a similar way, step 308 subjects the torque M_{clutch} transmitted by the clutch to a suitable decrease ΔM₂ when the engine's speed ω_{eng} is below the speed set-point value ω_{ref}, making it possible to achieve a corresponding acceleration of the engine's rotation speed. Suitable operation of the clutch to regulate M_{clutch} thus makes it possible for the engine to be accelerated/braked to desired speed.

The regulation here concerned is preferably continuous, in which case the method, after applying M_{clutch} at steps 307 and 308, goes back to step 305 to obtain new values for prevailing engine speed ω_{eng} and desired engine speed ω_{ref}, followed by applying M_{clutch} again on the basis of the new values. Continuous feedback from control unit 117 and demands received for desired engine speed thus make it possible for the speed regulator to use the clutch to continuously regulate the engine's speed ω_{eng} to desired speed ω_{ref}. A comprehensive function, e.g. a function which sees to it that setting the vehicle in motion is conducted in a desired way, may then determine when the engine speed regulation exemplified in FIG. 3 should be stopped, e.g. to ensure that the vehicle's running speed, and hence the rotation speed of the gearbox input shaft, have become such that the clutch can be closed completely. This is indicated by step 309, which may thus be reached from any step of the method illustrated in FIG. 3 when the setting in motion of the vehicle, or some other situation in which speed control according to the present invention is effected, has been completed and the clutch is for example to be closed or opened.

The present invention thus makes it possible for the engine to be guided to precisely desired speed by means of the clutch, while at the same time desired torque may be delivered by the engine.

In the embodiment exemplified above, speed regulation is based on knowledge of the torque delivered by the engine. As mentioned above, such knowledge is not necessary, since regulation of the engine's speed is also possible without this information. In this case it is assumed that the torque delivered by the engine is substantially constant, which may for example be assumed to be the case if the method illustrated in FIG. 3 is run through several times per second. The torque transmitted by the clutch continues to be determined by an equation of the above type, but instead by equation 2

$$\dot{ω} = \frac{{M}_{clutch , present} - {M}_{clutch , new}}{J} \qquad ( eq . 2 )$$

in which M_{clutch,present} is the torque transmitted at the time by the clutch and M_{clutch,new} the new torque to which the clutch is set during the regulation.

In other words, in cases where the torque delivered by the engine is regarded as constant, the relative difference in torque transmitted across the clutch will operate in precisely the same way as above and speed regulation may be by determining a relative change in the torque transmitted by the clutch, on the basis of desired rate of speed change, i.e. M_{clutch,present}−M_{clutch,new} may be determined in a straightforward way, it being easy for M_{clutch,new} to be determined and be set so as to achieve desired speed change. This form of regulation may also be used when the torque delivered by the engine changes, so long as the torque transmitted across the clutch can be regulated quickly relative to changes in the torque delivered by the engine.

Moreover, in one embodiment of the present invention, the speed regulator 406 or some other suitable function monitors the engine's prevailing speed relative to that of the gearbox input shaft to ensure continually that there is a rotation speed difference across the clutch, i.e. that the clutch slides. So long as the clutch is sliding, speed regulation of the engine may be conducted according to the present invention. This also means that the torque demanded from the engine, e.g. after a progressive torque increase according to some suitable function when setting the vehicle in motion as above, may for example take the form of a demand for a maximum torque, in which case control unit 117 may then continually endeavour to apply this maximum torque irrespective of prevailing engine speed. This torque may then be transmitted by the clutch in full, while at the same time sliding of the clutch may be ensured as above by means of the present invention.

So long as the clutch transmits precisely the torque generated by the engine, i.e. so long as M_{clutch}=M_{eng}, the speed of the engine will remain constant, whereas the speed of the gearbox input shaft may be constant or vary, if for example the propulsive force resulting from the torque delivered by the engine is sufficient to enable the vehicle to begin moving. The present invention may then be used to keep the engine's speed constant. It may for example be kept substantially at idling speed so long as the torque deliverable by the engine is sufficient and the engine's rotation speed is greater than that of the gearbox input shaft.

Once the engine's speed has for any reason to be changed, e.g. to enable a comprehensive function for the vehicle's move-off to determine that a torque greater than that deliverable at prevailing engine speed is required, desired speed is signalled to the speed regulator 406, whereupon the clutch is operated as above to achieve desired engine speed, making it possible for increased torque to be generated by the engine for transmission via the clutch. When the speed regulator determines that the engine has reached or is about to reach desired target speed, the torque transmitted by the clutch may be increased to the level delivered by the engine. Suitable control of the rate at which the torque transmitted across the clutch changes from a prevailing value to a desired value during speed regulation makes it possible to ensure that speed changes take place for example in a way which does not adversely affect driver comfort.

The speed regulator 406 ensures that the engine's speed never drops to the prevailing speed of the gearbox input shaft, and so long as the clutch is sliding it is possible to achieve very good regulation of the engine's speed without undesirable jerking or other fluctuations in the power train.

So long as the torque transmitted by the clutch as a function of the position of the friction element is substantially exactly determined, regulation may be conducted entirely according to equation 1. However, the characteristic of the clutch is usually estimated as above and may also change over time, e.g. because of wear and/or clutch temperature. This means that the M_{clutch} applied by means of the clutch characteristic is in practice likely to deviate somewhat from the modelled value. For this reason, a regulating error e may with advantage be used in the control of the clutch according to the invention. This applies in all of the above embodiments. The regulating error e may for example be the difference between the engine's desired speed ω_{ref} and its prevailing speed ω_{eng}, in which case e=ω_{ref}−ω_{eng}, or be a suitable function thereof.

This regulating error may then be used in regulating the engine's speed as above. One embodiment example uses a PI regulation in said regulation of the engine's speed by means of clutch control, which regulation may then for example be conducted according to

M_{clutch}=M_{ref}−eP−I∫e, (eq. 3)

in which P and I are set to suitable values which may for example be empirical or be determined in some other way. M_{ref} is the desired torque transmitted by the clutch, and M_{clutch} the torque which is intended to be applied by means of said clutch characteristic and which now therefore takes the form of the desired torque M_{ref} compensated for the regulating error e. Very accurate control is thus made possible even when the expected clutch characteristic does not exactly correspond to the actual clutch characteristic.

To sum up, the present invention thus proposes a method which makes it possible to take out more of the available torque from an engine than in prior art, without risk of loss of comfort, since no torque margin such as in prior art is required, as the engine's available torque can be fully utilised. The present invention also means that the engine's speed need not necessarily be raised other than when a torque available at a higher speed is required, or to ensure that the clutch slides.

As above, the specific way in which the torque delivered by the engine is to be controlled is not subject matter of the present invention, as it may be conducted in any suitable way. It may however be advantageous, e.g. from subfunction 404, to demand a torque from the engine which interacts with the speed control, e.g. to make it possible for the speed control to be conducted in a desired way. In one embodiment a torque is therefore demanded from the engine according to the equation M_{eng}=M_{ref}+\dot{ω}_{ref}J, while at the same time the clutch is for example operated according to equation 3. The torque demanded from the engine may thus be controlled on the basis of the speed to which the engine is to be regulated.

One skilled in the art will appreciate that in a regulation of the above kind there will in the system be delays which may be catered for by suitable adjustment of the regulation, which may be effected in a suitable way known to one skilled in the art.

The speed control according to the present invention requires the clutch to slide, since it is during sliding that the torque transmitted can be controlled by the clutch. It is generally the case that even when the clutch is in a partly opened state it may stop sliding and instead act like a closed clutch if the speed difference across it ceases. If such a situation occurs, the clutch may suddenly transmit substantially more torque, since it will then act like a closed clutch, i.e. the torque transmitted will instead be controlled by the engine despite the clutch not being fully closed, because the transmission characteristic of the clutch will differ depending on whether there is a prevailing speed difference (sliding) across it or not. The present invention does however mean that since the engine can be controlled with good accuracy its speed can also be kept low and the difference in rotation speed across the clutch be kept small. In one embodiment a safety margin with respect to the prevailing speed difference across the clutch may be applied, making it possible for the engine's speed to be controlled so that the speed difference across the clutch amounts to at least a first value. This value may however be kept relatively small and even if such a safety margin with respect to the speed difference across the clutch is applied there continues to be no need to use a safety margin with respect to the torque deliverable by the engine.

Further embodiments of the method and the system according to the invention are set out in the attached claims. It should also be noted that the system may be modified in different embodiments of the method according to the invention (and vice versa) and that the present invention is therefore in no way limited to the embodiments described above of the method according to the invention, but relates to and comprises every embodiment within the protective scope of the attached independent claims.

For example, although exemplified above with respect to a friction clutch, the invention is also applicable to other types of clutches. It is also exemplified above for a combustion engine but is of course also applicable for other types of prime movers, e.g. an electric motor. The invention is further exemplified above in relation to setting a vehicle in motion from stationary but is also applicable in other situations where control of the engine's speed may be conducted by means of the clutch.

The invention has also been exemplified for cases where torque is delivered from the engine and the rotation speed on the engine side of the clutch is greater than on the gearbox side. There are however situations in which the opposite relationship prevails but the present invention continues to be applicable. The vehicle may for example be travelling on a downgrade where the engine imparts a braking torque by running with the fuel supply switched off.

1. A method for regulating the speed of an engine (101) of a vehicle (100), which vehicle (100) is provided with a clutch (106) which is operated by a vehicle control system and adapted to selectively connecting said engine (101) to a gearbox (103) for transmission of torque, characterised in that, when the speed (ω_{eng}) of said engine is to be guided towards a set-point value (ω_{ref}), by the step of
regulating the speed (ω_{eng}) of said engine (101) by using said control system to regulate the torque (M_{clutch}) transmitted by said clutch (106).

2. A method according to claim 1, further comprising
determining said set-point value (ω_{ref}) for said speed of said engine (101), and
regulating the speed of said engine (101) towards said set-point value (ω_{ref}) by means of said clutch (106).

3. A method according to claim 1 or 2 which, when the speed (ω_{eng}) of said engine (101) is below said set-point value (ω_{ref}), further comprises
reducing the torque (M_{clutch}) transmitted by said clutch (106).

4. A method according to any one of claims 1-3 which, when the speed (ω_{eng}) of said engine (101) is above said set-point value (ω_{ref}), further comprises
increasing the torque (M_{clutch}) transmitted by said clutch (106).

5. A method according to any one of claims 2-4, in which said set-point value (ω_{ref}) for the speed of said engine (101) takes the form of a speed range.

6. A method according to any one of the foregoing claims, which, during said regulation of the speed (ω_{eng}) of said engine (101), further comprises operating said clutch (106) in such a way that said clutch (106) slides.

7. A method according to claim 6, in which, during said regulation, the speed (ω_{eng}) of the engine (101) is controlled in such a way that the speed difference across said clutch (106) amounts to at least a first value.

8. A method according to any one of the foregoing claims, in which during said regulation an increase or decrease (ΔM₁; ΔM₂) in the torque (M_{clutch}) transmitted by said clutch (106) is controlled on the basis of a speed difference between the speed (ω_{eng}) of said engine (101) and said set-point value (ω_{ref}) for the speed of said engine (101).

9. A method according to any one of the foregoing claims, in which, during said regulation, an increase or decrease (ΔM₁; ΔM₂) in the torque (M_{clutch}) transmitted by said clutch (106) is controlled on the basis of a desired acceleration or braking (\dot{ω}) of the speed (ω_{eng}) of said engine (101).

10. A method according to any one of the foregoing claims, in which an increase or decrease (ΔM₁; ΔM₂) in the torque transmitted by said clutch (106) is controlled by a difference between a torque (M_{clutch}) transmitted by said clutch (106) and a torque (ω_{eng}) delivered by said engine (101).

11. A method according to any one of the foregoing claims, in which the torque (M_{clutch}) transmitted by said clutch (106) is increased and reduced by using said vehicle control system to operate said clutch (106) in such a way that the torque (M_{clutch})transmissible by said clutch (106) is respectively increased or reduced.

12. A method according to any one of the foregoing claims, which, during said regulation of the speed of said engine (101), further comprises determining an error (e) in regulating the speed of said engine (101), and
controlling on the basis of said regulating error (e) the torque (M_{clutch}) transmitted by said clutch (106).

13. A method according to any one of the foregoing claims, in which said regulation of the speed (ω_{eng}) of said engine (101) takes place when said vehicle (100) is being set in motion.

14. A method according to any one of the foregoing claims, which is conducted when torque is being transmitted in a direction from the side of the clutch which presents the higher rotation speed towards the side of the clutch which presents the lower rotation speed.

15. A computer programme which comprises programme code and which, when said programme is executed in a computer, causes said computer to conduct the method according to any one of claims 1-14.

16. A computer programme product comprising a computer-readable medium and a computer programme according to claim 15, which programme is contained in said medium.

17. A system for regulating the speed of an engine (101) of a vehicle (100), which vehicle (100) is provided with a clutch (106) which is operated by a vehicle control system and adapted to selectively connecting said engine (101) to a gearbox (103) for transmission of torque, characterised in that the system comprises means, when the speed (ω_{eng}) of said engine (101) is to be guided towards a set-point value (ω_{ref}), for
regulating the speed (ω_{eng}) of said engine (101) by using said control system to regulate the torque (M_{clutch}) transmitted by said clutch (106).

18. A system according to claim 17, characterised in that said clutch (106) comprises a first clutch element (102) and a second clutch element (110), such that said first element (102) is firmly connected to, for joint rotation with, an output shaft of said engine (101), said first element (102) and second element (110) are selectively connected together to transmit force between said engine (101) and said gearbox (103), and said clutch (106) slides when a rotation speed difference prevails between said first element (102) and second element (110).

19. A vehicle (100), characterised by being provided with a system according to either of claims 17 and 18.
